(19) United States
(12) Patent Application Publication
(10) Pub. No.: US 2023/0309771 A1
(43) Pub. Date: Oct. 5, 2023

(54) Filter device and method for dedusting same

(71) Applicant: Hilti Aktiengesellschaft, Schaan (LI)

(72) Inventor: Oliver OHLENDORF, Landsberg (DE)

(21) Appl. No.: 18/024,653

(22) PCT Filed: Sep. 10, 2021
(86) PCT No.: PCT/EP2021/074946

§ 371 Date: Mar. 3, 2023

(30) Foreign Application Priority Data
Sep. 23, 2020 (EP) 20197753.5

(51) Int. Cl. A47L 9/20; A47L 9/12; A47L 5/36; B01D 46/12; B01D 46/58; B01D 46/74

(52) U.S. Cl. CPC A47L 9/20; A47L 9/122; A47L 5/365; B01D 46/12; B01D 46/58; B01D 46/74; B01D 2279/55

(57) ABSTRACT

A invention relates to a filter device for a vacuum cleaner having a turbine device and a motor for generating a first main air stream and/or a second main air stream through a collecting tank of the vacuum cleaner, wherein the vacuum cleaner includes two chambers and filter elements of the filter device are dedusted by an abrupt change in position of a pressure shock element in the chambers. Since, when one of the two chambers is being dedusted, the suction operation of the vacuum cleaner can be maintained through the other chamber, the filter dedusting can advantageously take place during continued suction operation of the vacuum cleaner. A method for dedusting a filter device in a vacuum cleaner, wherein, as a result of a valve being actuated, an air volume is driven out of one of the two chambers. As a result of this change in pressure, the pressure shock element is advantageously made to change position, and this can result in a backflushing pulse and mechanical shaking of the filter element, and dedusting of the filter device.

The invention relates to a filter device for a vacuum cleaner having a turbine device and a motor for generating a first and/or a second main air stream through a collecting tank of the vacuum cleaner.

### BACKGROUND

On construction sites, use is often made of vacuum cleaners in order to suck up or suck in dirt particles in the form of dust, drilling dust or the like. In order to collect the dirt, a negative pressure is generated inside the vacuum cleaner by means of a turbine. Via a hose, which is connected to the vacuum cleaner, the negative pressure is used in order to suck up dirt particles and transport them into a collecting tank of the vacuum cleaner. Commercially available vacuum cleaners are usually built such that the turbine, a filter, the collecting tank and the inlet opening for the sucked-in dirt particles are located one after another, or on a flow path. Usually, the filter is positioned between the collecting tank, or the inlet opening for the sucked-in dirt particles, and the turbine that generates a negative pressure. Since the sucked-in air containing dirt particles would flow through the turbine and consequently soil or damage the turbine, the filter serves to clean the sucked-in air and thus in particular to protect the turbine.

### SUMMARY OF THE INVENTION

However, a problem can arise when the filter can no longer provide a sufficient filtering function and sucked-in dirt particles can no longer be filtered out of the air flowing through the filter. This is the case in particular when, on account of the vacuum cleaner being used for a relatively long time, the filter is increasingly dirty, i.e. filled with dirt particles. In order to keep the filter functional, it has to be intermittently cleaned and freed of the dirt particles it has taken up. However, to clean the filter in commercially available vacuum cleaners, said vacuum cleaners have to be switched off, or the operation thereof interrupted, so that the cleaner can be opened and the filter taken out in order to remove the dirt particles it has taken up. Such activities interrupt the vacuuming process, however, and are very time-consuming.

According to the prior art, there already also exist vacuum cleaners that have an apparatus for dedusting the filter without the vacuum cleaner having to be switched off, opened and the filter taken out in order to remove the dirt particles it has taken up. A drawback of such apparatuses, however, is that, even in these vacuum cleaners, suction operation of the vacuum cleaner has to be interrupted while the filter is being dedusted. Alternatively, the suction operation can be continued with reduced power. In most cases, as a result of the suction being interrupted, the extraction performance of the vacuum cleaner drops and dust particles undesirably escape into the atmosphere, where they increase the dust concentration. Frequently, known filter dedusting apparatuses have a complex structure and are assembled from a large number of components. As a result, conventional filter dedusting apparatuses, as are known from the prior art, are frequently susceptible to faults or wear or in need of servicing.

For example, DE 10 2016 101 414 A1 discloses a vacuum cleaning appliance, for example a battery-operated portable vacuum cleaner, wherein an air filter of the vacuum cleaning appliance can be flowed through in the opposite direction to the suction operation direction during regeneration operation. In the case of this filter dedusting based on backflushing, the filter is mounted in particular in a displaceable manner in the vacuum cleaning appliance.

It is an object of the present invention to overcome the above-described deficiencies and drawbacks of the prior art and to provide an improved filter device for a vacuum cleaner, with which suction operation of the vacuum cleaner does not have to be interrupted while the filter is being dedusted.

The present invention provides a filter device for a vacuum cleaner, wherein the vacuum cleaner comprises a turbine device and a motor for generating a first and/or a second main air stream through a collecting tank of the vacuum cleaner. The filter device is characterized by the following features and components:
a first chamber and a second chamber, each with a filter element and an inflow opening, wherein a valve is designed to open or to close the inflow opening, wherein a negative pressure prevails in the chamber when the inflow opening is closed and wherein atmospheric pressure prevails in the chamber when the inflow opening is open,
wherein the chambers also each comprise a pressure shock element,
wherein the pressure shock elements can be in a parked position and in a dedusting position,
wherein a switchover between the parked position and the dedusting position takes place by letting in the atmospheric pressure, this being effected by actuating the valve,
wherein the pressure shock elements are designed to apply a pulse to the respective filter element when the dedusting position is taken up, such that the filter element is dedusted.

Tests have shown that the filter device ensures a good and interruption-free extraction performance. As a result of the advantageous cooperation and the specific design of the valves and the pressure shock elements, and the pressure distribution, controlled thereby, in the different regions of the vacuum cleaner, alternate dedusting of the two chambers with, at the same time, ongoing suction operation of the other chamber in each case can be allowed. As a result, a highly efficient possibility, optimized in terms of installation space, for filter dedusting is provided in a vacuum cleaner. The filter device in particular has a relatively simple structure. Use tests have shown that the filter device is particularly robust and not very susceptible to repairs and wear. In particular the pressure shock elements provided in the chambers contribute to these advantages of the invention, said pressure shock elements preferably being designed to apply a dedusting pulse to the respective filter element when the dedusting position is taken up. According to the invention, this dedusting pulse can also be referred to as backflushing pulse. In addition to the backflushing pulse, the filter element is mechanically shaken by the opening of the valve. As a result of the shaking, dust particles and filter cakes are detached from the filter element and can drop into the collecting tank of the vacuum cleaner. The shaking of the filter element preferably represents backflushing of the filter device, this being used in the context of the present invention in order to dedust the filter of the vacuum cleaner.

According to the invention, it is preferred that the pressure shock elements are designed to be movable within the chambers. In the chambers, in particular axial guides can be provided, along which the pressure shock element can move in a top-bottom movement. According to the invention, such a top-bottom movement is preferably referred to as a vertical movement. According to the invention, the expression “vertical movement” should be understood as meaning that a movement of the pressure shock elements runs substantially vertically, wherein a person skilled in the art is aware that—for example for design reasons or on account of play—slight deviations from mathematically exact verticality can occur. For example, the top-bottom movement of the pressure shock elements can deviate from an exact vertical axis by +/−5 degrees. The movement of the pressure shock elements in a vertical direction is associated with the advantage that the movement of the pressure shock elements is supported by gravity during a downward movement. As a result, a particularly strong and effective dedusting pulse can be applied to the filter of the vacuum cleaner.

The provision of a first and a second chamber in the context of the filter device should be understood as meaning that the filter device preferably has at least two chambers. According to the invention, it may also be preferred that the filter device has more than two chambers, for example three or four chambers. According to the invention, it is preferred that when the filter device comprises two chambers, the two chambers are arranged substantially alongside one another in the vacuum cleaner. The chambers can be arranged for example at approximately the same height in the dust collecting tank of the vacuum cleaner.

In a first embodiment of the invention, the main air streams can flow into the chambers from the side and subsequently be deflected into a vertical flow. This embodiment of the invention is illustrated for example in FIG. 1. In a second embodiment of the invention, the main air streams can flow into the chambers from below and form a vertical flow. In this second preferred configuration of the invention, the chambers and their components are arranged as if they had been rotated through 90 degrees compared with the first configuration of the invention. This second embodiment of the invention is illustrated for example in FIGS. 2 to 11. As a result of this arrangement of the filter elements within the vacuum cleaner, it can be even easier to dedust the filter because the filter pleats are downwardly free and can thus be dedusted better.

According to the invention, the movability of the pressure shock elements preferably means that the pressure shock elements can be arranged in two different positions within the respective chamber, specifically in a parked position or in a dedusting position. The pressure shock elements can move in particular from one position to the other and also take up any intermediate position. The two different states in which the pressure shock elements can be arranged are indicated for example in FIGS. 4 to 6, in which the pressure shock elements of the chambers are arranged in different states. In the first chamber of the vacuum cleaner, which is illustrated in the left-hand half of the figure, the pressure shock element is in the suction operation position, which is also referred to as the parked position according to the invention. In the second chamber of the vacuum cleaner, which is illustrated in the right-hand half of FIGS. 4 to 6, the pressure shock element is in the dedusting position. In this position of the pressure shock element, the filter in the right-hand chamber of the filter device can be dedusted, while the suction operation of the vacuum cleaner is maintained via the left-hand chamber.

In the dedusting position, the pressure shock elements are designed to split the chambers of the vacuum cleaner into a front space and a rear space. The front chamber is preferably arranged in the vicinity of the filter element of the respective chamber, while the rear space of the chamber is preferably connected to a ventilation channel. Preferably each of the two chambers has a ventilation channel with which the chamber can be connected to the environment of the vacuum cleaner. Located in the ventilation channel is a ventilation valve, which is preferably also referred to as a “valve” according to the invention. The valve is designed to connect the respective chamber of the vacuum cleaner in terms of flow to the environment of the vacuum cleaner or to close off the connection. In other words, the ventilation channels can be opened or closed by the respective ventilation valve. When the ventilation valve is closed, there is no fluidic connection between the chamber and the vacuum cleaner environment. There is in particular no pressure equalization between the chamber and the environment of the vacuum cleaner in this position of the ventilation valve. This preferably means, according to the invention, that preferably a negative pressure prevails in the chamber of the vacuum cleaner, while atmospheric pressure prevails in the environment of the vacuum cleaner. Thus, the negative pressure, which is generated by the turbine of the vacuum cleaner, prevails in the chamber in order to ensure the suction operation of the vacuum cleaner. When the ventilation valve is open, a pressure equalizing stream can flow through the ventilation channel into the vacuum cleaner and into the chamber, such that pressure equalization can take place between the suction operation negative pressure in the initially closed chamber and the atmospheric pressure in the environment of the vacuum cleaner. This pressure equalizing stream, or the penetration of atmospheric pressure into the chamber, advantageously has the result that the pressure shock element in the chamber is pushed downward. In other words, the pressure equalization causes a downward vertical movement of the pressure shock element. As a result of this vertical movement of the pressure shock element, the air in the front region of the chamber is compressed and a dedusting pulse is generated. Furthermore, as a result of the downward movement of the pressure shock element, the filter device is mechanically shaken. As a result of the mechanical shaking and/or the dedusting pulse, a filter cake can detach from the filter of the chamber to be dedusted and drop into the dust collecting tank of the vacuum cleaner. In other words, as a result of the mechanical shaking, and as a result of the dedusting pulse, one of the two filters of the filter device can be dedusted. This filter dedusting corresponds preferably to a backflushing process, which advantageously results in the filter being freed of any filter cake. The pressure equalizing stream flows through the inflow opening into the first or into the second chamber, wherein the inflow openings represent transitional regions between the chambers and the ventilation channels associated therewith. The ventilation channels are connected to the chambers via the inflow openings and are preferably constituents of the filter device, and of the disclosed vacuum cleaner.

According to the invention, it is preferred that the filter device has turbine openings which are designed to allow a flow connection between the chambers of the filter device and the turbine device. According to the invention, it is particularly preferred that the chambers of the filter device each comprise a turbine opening. The turbine openings may preferably be present in side walls of the chambers and/or in the axial guides within the chambers. If the turbine openings are arranged in the axial guides, internal extraction through the inner axial guide is realized by the invention, and it is possible to dispense with the lateral turbine channels. As a result, the production of the filter device can be simplified further. The inner axial guides with turbine openings can preferably be formed by a tube with lateral opening slots. According to the invention, it is preferred that the turbine openings are closed by the change in position of the pressure shock element. According to the invention, the turbine device can preferably also be referred to as a suction device.

The vertical downward movement of the pressure shock element when the ventilation valve is opened preferably also has the result that the turbine opening in the chamber to be dedusted is closed. This can take place in particular in that the pressure shock element or parts thereof slide in front of the turbine opening such that the turbine opening is closed. As a result, the chamber is cut off from the turbine suction stream and so a negative pressure can no longer be built up or maintained in the chamber to be dedusted. In FIG. 5, by way of example, the turbine opening of the right-hand chamber is closed by the right-hand pressure shock element.

Filter dedusting can be ended in that the ventilation valve and thus the ventilation channel of the chamber is closed by the freshly dedusted filter. As a result, the pressure shock element of this chamber can return from its dedusting position into the parked position. The restoration of the pressure shock elements can be supported by the provision of bypass channels and/or compression springs. The return of the pressure shock element from the dedusting position into the parked position preferably has the result that a negative pressure can again be built up in the freshly dedusted chamber and suction operation can be carried out. This is achieved in particular in that, upon returning from the dedusting position into the parked position, the pressure shock element opens up the turbine opening in the chamber again such that air can be extracted from the chamber by the turbine and a suction stream for suction operation of the vacuum cleaner can be generated.

According to the invention, it is preferred that the front space of a chamber is formed between the filter element and the pressure shock element and the rear space is connected to the ventilation channel. The inflow opening of the first or of the second chamber can be closed or opened up by a valve, wherein the corresponding chamber can be dedusted when the ventilation valve is open, and wherein suction operation can be maintained with the corresponding chamber when the ventilation valve is closed and a negative pressure can build up in the corresponding chamber. In other words, according to the invention, it is preferred that the ventilation channels which are each connected to one of the two chambers comprise a valve, wherein the valves are designed to open or close the inflow opening of a chamber.

According to the invention, it is preferred that the turbine opening is designed to allow a flow connection between one of the chambers and the turbine, wherein this flow connection exists between the chambers and the turbine device, i.e. is open, in particular during operation of the vacuum cleaner. Preferably, the flow connection is formed by a flow channel portion that is formed between the turbine opening of one of the chambers and the turbine. This flow channel portion is open in particular during operation of the vacuum cleaner in order that the negative pressure generated by the turbine can be used to suck in or up dust. According to the invention, the position of the pressure shock element in which suction operation is allowed through the respective chamber is preferably referred to as the “first position”, “parked position” or “suction operation position” of the pressure shock element. In this first position of the pressure shock element, the turbine opening of one chamber is open while the inflow opening to the ventilation channel, or the ventilation channel itself, is closed. In the second position of the pressure shock element, which is also referred to as the dedusting position according to the invention, the turbine opening is closed, while the inflow opening or the ventilation channel is open.

According to the invention, it is preferred that a negative pressure prevails in the corresponding chamber when the associated inflow opening is closed and the turbine opening is open, i.e. the pressure shock element of the corresponding chamber is in the suction operation position or in the parked position. In this case, extraction operation takes place through the corresponding chamber and dust particles can be sucked into the collecting tank by the associated main air stream. According to the invention, it is also preferred that, during suction operation through the one chamber, the filter element in the other chamber can be dedusted. In order to effect dedusting of the filter element, the valve of the other chamber can be actuated such that the inflow opening is opened, a fluidic connection is established between the chamber to be dedusted and the vacuum cleaner environment, and pressure equalization can occur in the chamber to be dedusted. In this case, atmospheric pressure enters this chamber to be dedusted. As a result of the pressure equalization, the pressure shock element in the chamber to be dedusted is moved downward, with the result that advantageously the turbine opening of this chamber is closed. The pressure shock elements are designed to apply a pulse to the respective filter element when the dedusting position is taken up, such that the filter element is dedusted. In particular, a dedusting shock or a dedusting pulse is applied to the filter element by the pressure shock element.

It is provided that each chamber comprises a pressure shock element which can be in a parked position and in a dedusting position. A switchover between the parked position and the dedusting position can advantageously take place by letting in the atmospheric pressure, wherein the letting in is effected by actuating the ventilation valve in the ventilation channel of the vacuum cleaner. According to the invention, the actuation of the valve means preferably that the valve is shifted from a first position into a second, or vice versa. In other words, upon actuation of the valve, the valve is moved from the suction operation position into the filter dedusting position. In the open position, the pressure shock elements allow the main air streams, which form between the dust collecting chamber and turbine in suction operation, through the turbine opening. If the ventilation valve is now moved from the suction operation position into the filter dedusting position, the negative pressure in the chamber to be dedusted is weakened, wherein the suction operation of the vacuuming apparatus can advantageously be maintained through the other chamber. According to the invention, the weakening of the negative pressure can be brought about in that a pressure equalizing stream is guided into the chamber to be dedusted from the environment of the vacuum cleaner. This preferably takes place through the ventilation channel and the inflow opening of the corresponding chambers. The letting in of the pressure equalizing stream advantageously has the result that a negative pressure no longer prevails in the chamber to be dedusted.

According to the invention, it is preferred that, as a result of the valve being actuated, the inflow opening between the chamber and ventilation channel is opened, and a fluidic connection between the chamber to be dedusted and the vacuum cleaner environment is created such that, on account of the negative pressure, existing during suction operation, in the chamber, an air stream (“pressure equalizing stream”) into the chamber arises, said air stream pushing the corresponding pressure shock element down. As a result, the turbine opening can be closed and the main air stream that forms between the dust collecting tank and turbine during suction operation is no longer allowed through by the pressure shock element. In other words, in this filter dedusting position, the pressure shock element blocks one of the two main air streams. As a result of the air blast that penetrates abruptly through the opened inflow opening and the ventilation channel, not only is the pressure shock element made to move downward substantially vertically along an axial guide, but also the pressure shock element is accelerated with great force or high acceleration in the direction of the filter element of the corresponding chamber. In the context of the present invention, this abrupt movement of the pressure shock element is referred to as “taking up the dedusting position”, with the result that the pressure shock element applies a backflushing pulse to the respective filter element. As a result of this pulse, the filter element can preferably additionally be mechanically shaken, such that advantageously the filter element is mechanically dedusted. Preferably, the pulse can be transmitted by contact between the dividing and filter element or contactlessly by compression of the air between the elements.

According to the invention, it is preferred that a mechanical stop is provided between the pressure shock element and the filter element. This stop can be formed for example as a grating or as a grating element. Preferably, the mechanical stop is designed to transmit a shock pulse or the backflushing pulse to the filter element.

According to the invention, it is preferred that the collecting tank forms the lower region of the vacuum cleaner, in which the dust sucked in by the vacuum cleaner is captured and stored until the vacuum cleaner is emptied. Preferably, the first and the second chamber of the vacuum cleaner are constituents of the collecting tank. In other words, the first chamber and the second chamber are arranged in the collecting tank of the vacuum cleaner. In a preferred configuration of the invention, the chambers have inlet openings which are delimited with respect to the collecting tank by filter elements. Preferably, the filter elements are designed to close off the inlet openings such that dust particles can be filtered out of the main air streams, wherein, during suction operation, the main air streams are formed between the suction hose inlet of the dust collecting tank and the turbine. It is these filter elements between the chambers and the remaining volume of the collecting tank that are intended to be dedusted in the context of the present invention. As a result of the preferably direct and immediate connection between the filter elements and the collecting tank, dust particles and filter cakes that are detached from the filter elements during dedusting can pass directly into the collecting tank and be disposed of the next time the tank is emptied.

The suction head preferably forms the upper region of the vacuum cleaner; it is preferably also referred to as the “vacuum cleaner head”. The suction head preferably comprises the turbine device of the vacuum cleaner, and a motor. According to the invention, it is preferred that the turbine is a constituent of an extraction device within the vacuum cleaner. The motor serves to drive the turbine, or to allow operation of the vacuum cleaner. The vacuum cleaner may comprise ventilation channels, which may be arranged for example between the suction head and the collecting tank. According to the invention, it may also be preferred for the ventilation channels to be arranged in the suction head. The ventilation channels may preferably have ventilation openings or ventilation slots, through which air can be sucked into the interior of the vacuum cleaner. According to the invention, it is particularly preferred that the air is sucked into the ventilation channels, wherein the air can pass from there into the chambers of the filter device when the corresponding ventilation valves are open or open up the inflow openings of the chambers. The air stream from the ventilation channel into the chamber to be dedusted forms, in a particularly preferred configuration of the invention, a pressure equalizing stream, which can pass through the open valve and through the inflow opening from the ventilation channel into the chamber. In other words, when the first or second valve is opened, a pressure equalizing stream can pass into the first chamber or into the second chamber of the vacuum cleaner. According to the invention, it is preferred that the valves can each be moved, i.e. opened or closed, by a respective adjusting element. The adjusting elements can be present for example in the ventilation channels, preferably in the vicinity of a further side wall, which preferably forms a partition wall between the ventilation channel and the first or the second chamber of the vacuum cleaner.

According to the invention, it is preferred that, during operation of the vacuum cleaner, a negative pressure prevails in the collecting tank and in at least one of the two chambers. Preferably, the negative pressure can be generated by the turbine device in the suction head. By means of the negative pressure, dust particles or drilling dust can be sucked into the interior of the vacuum cleaner. The collecting tank of the vacuum cleaner preferably has a suction hose inlet, through which the dust particles or the drilling dust can be sucked in, in particular when the inlet is connected to a suction hose and the vacuum cleaner is in suction operation. Suction operation is preferably characterized in that the vacuum cleaner generates a negative pressure with its turbine device. The suction operation generates main air streams through the chambers of the vacuum cleaner that participate in suction operation, wherein the main air streams preferably flow from the suction hose inlet to the turbine device. The first main air stream passes through the suction hose inlet into the collecting tank and flows through the first filter element into the front region of the first chamber. When the first chamber participates in the suction operation of the vacuum cleaner, the ventilation channel of the first chamber is closed by the ventilation valve (suction operation position of the valve). According to the invention, it is preferred that the chambers participating in suction operation are in a flow connection with the turbine device of the vacuum cleaner. To this end, the chambers each comprise a turbine opening, which allows a flow connection between the chambers and the turbine device. According to the invention, it is preferred that this turbine opening can be opened, i.e. opened up, or closed by the pressure shock element.

According to the invention, it is preferred that the chambers each comprise an inflow opening and a turbine opening, wherein the turbine openings are designed to allow a flow connection between the chambers and the turbine device, and the inflow opening forms the transition between the chambers and the respective ventilation channels.

In one exemplary embodiment of the invention, it is preferred that, in a vacuuming apparatus,
a first chamber comprises a first filter element and a first inflow opening, wherein the first inflow opening is able to be closed off with respect to a first ventilation channel by a first ventilation valve, wherein the first chamber also comprises a first pressure shock element; and
a second chamber comprises a second filter element and a second inflow opening, wherein the second inflow opening is able to be closed off with respect to a second ventilation channel by a second ventilation valve, wherein the second chamber also comprises a second pressure shock element,
wherein the pressure shock element or the ventilation valve can be in a parked position and in a dedusting position, wherein a switchover between the parked position and the dedusting position of the pressure shock element takes place by means of atmospheric pressure, which is able to be created in the first chamber or in the second chamber by opening the first valve or the second valve, wherein the pressure shock elements are designed, when the dedusting position is taken up, to apply a backflushing pulse to the respective filter element such that a backflushing air movement and any additional mechanical shaking and, as a result, dedusting of the respective filter element is brought about.

In a second aspect, the invention relates to a method for dedusting a filter device in a vacuum cleaner, wherein the method is characterized by the following steps:
a) providing a filter device in a vacuum cleaner,
b) operating the vacuum cleaner, wherein, during operation of the vacuum cleaner, a negative pressure prevails in a collecting tank of the vacuum cleaner and in at least a first chamber and/or in a second chamber of the vacuum cleaner,
c) generating atmospheric pressure in one of the chambers by actuating a valve, wherein, as a result of the valve being actuated, an inflow opening of the chamber is opened and a pressure shock element within the chamber is made to change position from a parked position into a dedusting position,
d) dedusting a filter element by the change in position of the pressure shock element.

According to the invention, it is preferred that the change in position of the pressure shock element can preferably also be referred to as a position change or as a switchover from a first position into a second. This change in position takes place preferably suddenly or abruptly, such that the pressure shock element is moved with a large pulse. This movement is preferably a sudden or abrupt downward movement of the pressure shock element, this movement preferably also being referred to as a “vertical movement” according to the invention.

According to the invention, it is preferred that, as a result of the ventilation valve being actuated, the negative pressure is driven out of one of the two chambers by the inflow opening being opened. As a result, atmospheric pressure can flow into the chamber to be ventilated from the environment of the vacuum cleaner. According to the invention, it is preferred that, as a result of the change in position of the pressure shock element, the turbine openings of the chambers are also closed. As a result of this change in pressure, which preferably represents pressure equalization with regard to the pressure prevailing in the environment of the vacuum cleaner, a change in position of the pressure shock element can advantageously be brought about, this resulting, in addition to the backflushing pulse, in the filter element being mechanically shaken and the filter device being dedusted.

According to the invention, it is preferred that the filter elements of the filter device can be dedusted alternately. The respectively other chamber advantageously ensures the suction operation of the vacuum cleaner. Preferably, the filter dedusting processes can take place substantially seamlessly, i.e. without a break and a time delay. However, according to the invention, it may also be preferred for there to be breaks between the filter dedusting processes of the chambers. In these breaks, it is preferred for both chambers to participate in the suction operation of the vacuum cleaner.

According to the invention, it is preferred that, when the inflow opening is opened, as a result of the ventilation valves being opened, a pressure equalizing stream passes into the first chamber or into the second chamber, with the result that atmospheric pressure propagates in the corresponding chamber. According to the invention, it is furthermore preferred that the pressure equalizing stream is sucked in from a ventilation channel, wherein the ventilation channel can have ventilation openings or slots in the direction of the environment of the vacuum cleaner. Through these ventilation openings or slots in the ventilation channel, air can preferably be sucked in from the environment of the vacuum cleaner when the ventilation valve in the ventilation channel, and the inflow opening of the chamber to be dedusted are open. The sucked-in air preferably forms the pressure equalizing stream, which causes the corresponding pressure shock element to move down.

According to the invention, it is preferred that, during operation of the vacuum cleaner, there is a flow connection between the chambers and the turbine device, wherein the flow connection represents a flow channel portion that is formed between a turbine opening of one of the chambers and the turbine device. According to the invention, it is preferred that the first main air stream and/or the second main air stream can flow through this flow connection.

It is an essential advantage of the invention that the dedusting of the filter element of the one chamber can take place while suction operation through the other chamber continues.

In particular, the invention also relates to a vacuum cleaner having a filter device according to the invention. The definitions, technical effects and advantages that have been described for the filter device apply analogously to the filter dedusting method and the vacuum cleaner, which has a filter device.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce useful further combinations.

In the figures, identical and similar components are denoted by the same reference signs.

In the figures:

FIG. 1 shows a schematic side view of a vacuum cleaner having a preferred embodiment of the filter device with main air streams flowing in from the side

FIG. 2 shows a schematic illustration of the vacuum cleaner while both chambers are participating in suction operation

FIG. 3 shows a schematic illustration of the vacuum cleaner at the start of filter dedusting of the second chamber

FIG. 4 shows a schematic illustration of the vacuum cleaner while the filter element of the second chamber is being dedusted

FIG. 5 shows a schematic illustration of the vacuum cleaner while the filter element of the second chamber is being dedusted

FIG. 6 shows a schematic illustration of the vacuum cleaner at the end of the dedusting process of the second chamber

FIG. 7 shows a schematic illustration of the vacuum cleaner at the start of filter dedusting of the first chamber FIG. 8 shows a schematic illustration of the vacuum cleaner while the filter element of the first chamber is being dedusted

FIG. 9 shows a schematic illustration of the vacuum cleaner at the end of the dedusting process of the first chamber

FIG. 10 shows a schematic side view of a vacuum cleaner during the restoration of the pressure shock elements

FIG. 11 shows a schematic side view of a vacuum cleaner having a preferred embodiment of the filter device in a horizontal arrangement

FIG. 12 shows a schematic illustration of the vacuum cleaner while both chambers are participating in suction operation, wherein the turbine openings are present in the axial guides

### DETAILED DESCRIPTION

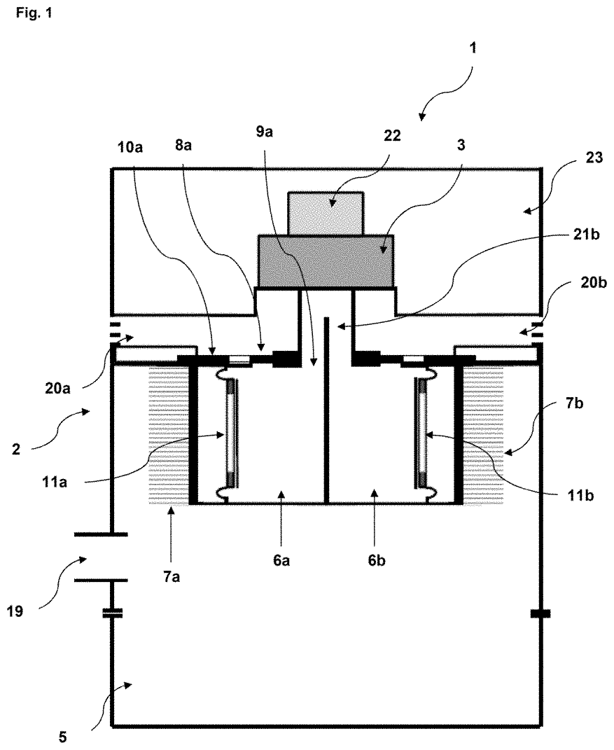

FIG. 1 shows a side view of a vacuum cleaner 1 having a preferred embodiment of the filter device 2 in a vertical arrangement. According to the invention, the wording “vertical arrangement” preferably means that a main air stream 4a, 4b initially flows into the chambers 6a, 6b from the side before the main air stream 4a, 4b is deflected in the chambers 6a, 6b such that it flows preferably in an upward spatial direction, i.e. preferably in the direction of the turbine 3 of the vacuum cleaner 1. Illustrated in a lower region of the vacuum cleaner 1 is the dust collecting tank 5, which has a suction hose inlet 19. A suction hose, which can be connected for example to a floor nozzle, can be attached to this suction hose inlet 19. Through the suction hose, dust particles or drilling dust can be sucked in. The sucked-in dust then passes through the suction hose inlet 19 into the dust collecting tank 5 of the vacuum cleaner 1.

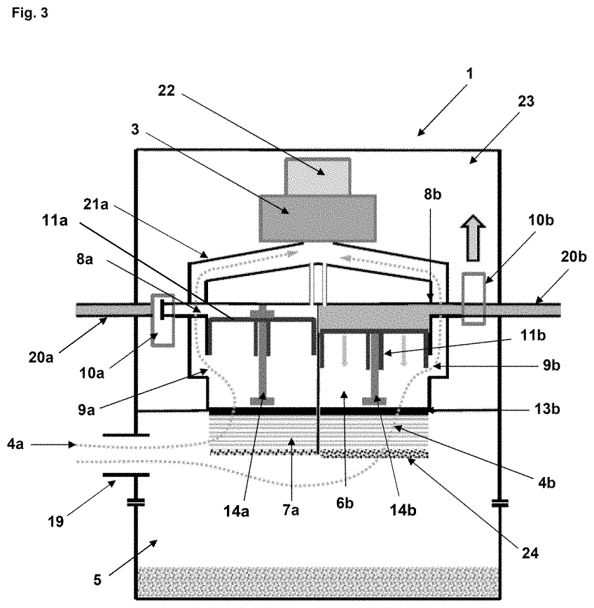

The upper region of the vacuum cleaner 1 is formed by a vacuum cleaner head 23. Located in the vacuum cleaner head are, for example, the turbine 3 and the motor 22, with which the negative pressure for sucking in the dust particles and drilling dust is generated. The vacuum cleaner 1 has ventilation channels 20a, 20b with which air can be sucked in from the environment of the vacuum cleaner 1 through openings in the housing. This air sucked in through the ventilation channels 20, 20b can form for example a pressure equalizing stream when pressure equalization is intended to take place in the vacuum cleaner 1, or the chambers 6a, 6b thereof. This can be the case for example when the negative pressure within a chamber 6a, 6b of the vacuum cleaner 1 is intended to be interrupted in order to carry out filter dedusting. It is necessary to dedust the filter elements 7a, 7b for example when the filter elements 7a, 7b of the filter device 2 are clogged with dust. The initially loose dust can solidify to form a filter cake 24 (see, e.g., FIG. 3), which can be detached from the filter elements 7a, 7b only with difficulty. In order to provide effective filter dedusting in which in particular the suction operation of the vacuum cleaner 1 does not need to be interrupted, the invention is presented in the following text:

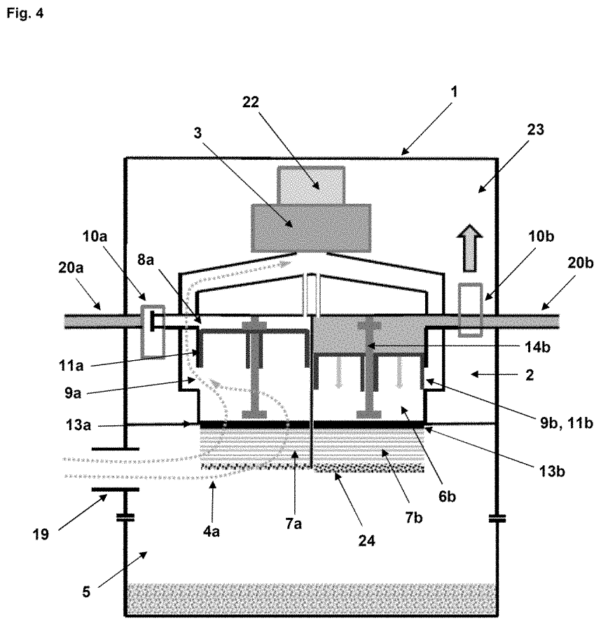

Provided between the dust collecting tank 5 and the vacuum cleaner head 23 are two chambers 6a, 6b, the filters 7a, 7b of which can be dedusted alternately according to the invention, while the suction operation of the vacuum cleaner 1 can be continued in the respectively other chamber 6a, 6b. The chambers 6a, 6b are formed in a substantially identical manner, for example axisymmetrically to a partition wall separating the two chambers, and so in particular the first chamber 6a is described in the following text. This is the left-hand chamber in the figures. Located in terms of flow in a front region of the chamber 6a is an inlet opening 13a (see, e.g., FIG. 4), through which the dust-laden air stream 4a is sucked from the dust collecting tank 5 in the direction of the turbine 3. In order to protect the turbine 3 from the dust, a filter element 7a is provided upstream of the inflow opening 13a, said filter element 7a being designed to filter a substantial proportion of the dust out of the air stream 4a. According to the invention, it is preferred that the filter elements 7a, 7b can consist of two separate filters. Alternatively, the filter elements 7a, 7b can be formed by a filter that is subdivided into two filter elements. Once the air stream 4a has passed through the inlet opening 13a and the filter element 7a, the air stream 4a passes into a front space of the first chamber 6a. Provided in the first chamber 6a is a pressure shock element 11a. The pressure shock element 11a can be present in two states, wherein the pressure shock element 11a is preferably in a parked position during suction operation of the first chamber 6a. The parked position of the first pressure shock element 11a is, in particular, characterized in that a turbine opening 9a of the first chamber 6a is opened up such that the main air stream 4a can pass or be sucked from the first chamber 6a into the flow channel portion 21. The pressure shock elements 11a, 11b can be guided by axial guides 14a, 14b so as to allow a substantially vertical up and down movement of the pressure shock elements 11a, 11b.

The rear space of the first chamber 6a has an inflow opening 8a which opens into a first ventilation channel 20a. The ventilation channel 20a has ventilation openings or slots via which air can flow into the ventilation channel 20a from the environment of the vacuum cleaner. In order to allow this, a first valve 10a is provided in the ventilation channel 20a, with which the ventilation openings or slots in the ventilation channel 20a can be opened or closed. When the valve 10a in the ventilation channel 20a is open, this is preferably referred to, according to the invention, as the filter dedusting position, while the valve 10a is in the closed state in the suction operation position.

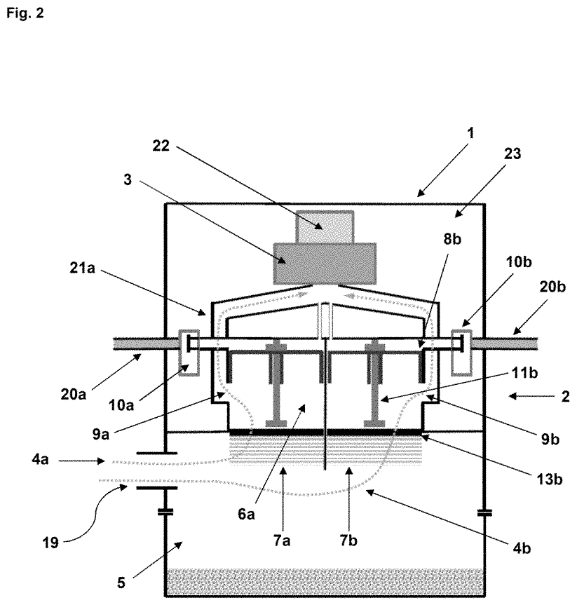

In FIG. 2, the turbine openings 9a, 9b can also be seen, which are preferably constituents of the filter device 2. The turbine openings 9a, 9b can be present in side walls of the chambers 6a, 6b. This configuration of the invention is illustrated in FIG. 2. However, the turbine openings 9a, 9b can also be present in the axial guides 14a, 14b, which are designed to guide the movement of the pressure shock elements 11a, 11b. In this case, internal extraction is realized and it is possible to dispense with outer turbine channels, for example the flow channel portion 21, in the construction of the filter device 2. This makes it easier and simpler to produce the filter device 2.

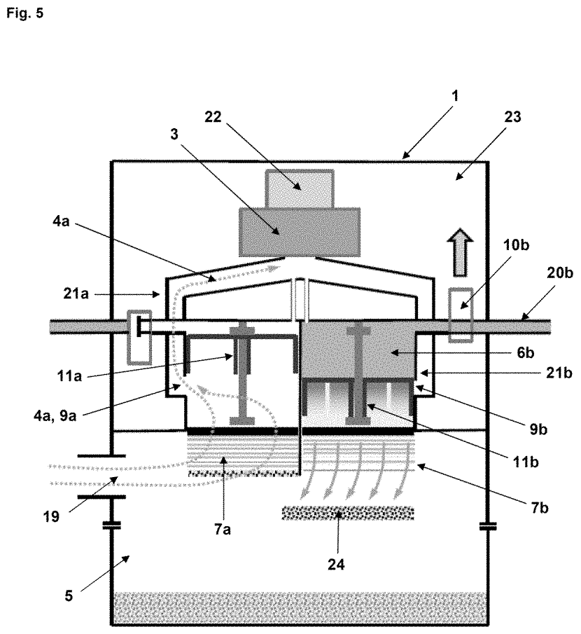

During suction operation of the first chamber 6a—as depicted for example in FIGS. 4 and 5—the valve 10a is set such that a turbine opening 9a of the first chamber 6a is open. Through the open turbine opening 9a, there is a flow connection between the first chamber 6a and the turbine 3. As a result, a negative pressure prevails in the first chamber 6a, and in the entire dust collecting tank 5 of the vacuum cleaner 1, such that dust can be sucked into the interior of the vacuum cleaner through the suction hose inlet 19. In particular, the air stream 4a can pass through the open turbine opening 9a into the region of the turbine 3. To this end, the air stream 4a can flow through a flow channel portion 21a that is provided between the turbine opening 9a and the turbine 3.

FIGS. 2 and 3 show a schematic illustration of the vacuum cleaner 1 while both chambers 6a, 6b are participating in suction operation. The dark regions in FIGS. 3 to 5, 7 and 8 are intended to represent the regions of the vacuum cleaner 1 in which atmospheric pressure prevails. In the exemplary embodiment of the invention that is illustrated in FIG. 2, both valves 10a, 10b of the vacuum cleaner 1 are in the suction operation position and the pressure shock elements 11a, 11b of the two chambers 6a, 6b are each in the parked position, such that the air streams 4a and 4b can flow from the dust collecting tank 5 through the filter elements 7a, 7b in the direction of the turbine 3. In the process, the main air streams 4a, 4b flow past the pressure shock elements and pass unimpeded into the flow channel portions 21a, 21b.

The suction operation mode of the vacuum cleaner 1 is in particular characterized in that a negative pressure prevails in the dust collecting tank 5 and in the chambers 6a, 6b that participate in suction operation. This negative pressure also prevails in the flow channel portions 21a, 21b of the chambers 6a, 6b participating in suction operation. The negative pressure is generated by the turbine 3 and the motor 22 and is responsible for the formation of the air streams 4a and 4b that allow air and dust to be sucked into the vacuum cleaner 1.

As a result of the suction operation of the vacuum cleaner 1, the filter elements 7a, 7b can become clogged with dust with the result that the filtering capacity is reduced. This can represent a risk to the motor 22 and the turbine 3 when these components of the vacuum cleaner 1 are exposed to too much dust. Therefore, the filter elements 7a, 7b of the filter device 2 are regularly dedusted so that for example solidified filter cake 24 can be detached from the filter elements 7a, 7b. To this end, a filter dedusting process is initiated in one of the two chambers 6a, 6b. The start of filter dedusting of the second chamber 6b is illustrated starting with FIG. 3.

In the following text, a filter dedusting process of the second chamber 6b of the vacuum cleaner 1, or of the filter element 7b of the second chamber 6b of the vacuum cleaner 1 is described. The second chamber 6b is depicted on the right-hand side of the vacuum cleaner 1 in the figures. The filter dedusting process is started by actuating the valve 10b, which can be shifted for example from the suction operation position into the filter dedusting position. The opening of the ventilation valve 10b is symbolized in FIG. 3 by the outlined upward arrow above the valve 10b. As a result of the valve 10b being actuated, the ventilation channel 20b of the second chamber 6b, or the inflow opening 8b of the second chamber 6b, is opened and a pressure equalizing stream can flow into the second chamber 6b. The pressure equalizing stream is preferably formed by air that is sucked into the second ventilation channel 20b through the ventilation openings and slots, wherein this air can pass into the second chamber 6b of the vacuum cleaner 1 through the inflow opening 8b. The pressure equalizing stream preferably ensures that pressure equalization takes place in the second chamber 6b, i.e. the prevailing negative pressure collapses and is driven out by the atmospheric pressure prevailing in the environment of the vacuum cleaner 1. As a result of the penetration of atmospheric pressure, the pressure shock element 11b in the second chamber 6b is made to move down. The downward movement of the pressure shock element 11b is represented by the dark arrows without an outline beneath the pressure shock element 11b. In this case, both arrows point downward, i.e. in the direction of the downward movement of the pressure shock element 11b. The abovementioned arrows are also included in FIG. 4. In other words, the second pressure shock element 11b moves down and carries out a vertical movement. As a result of this substantially vertical downward movement, the air that remained between the pressure shock element 11b and the filter element 7b can be compressed. As a result, a dedusting pulse is generated, which advantageously acts on the filter element 7b and dedusts the latter in that the filter cake 24 is detached and can drop into the dust collecting tank 5 of the vacuum cleaner 1. Furthermore, the filter 7b can be mechanically shaken by the pressure shock element 11b, with the result that the dedusting of the filter 7b is even more effective. According to the invention, it is preferred that parts of the pressure shock elements 11a, 11b fill a width of the chambers 6a, 6b substantially over the entire area such that the pressure shock elements 11a, 11b are pushed down particularly readily and effectively by the penetrating pressure equalizing stream.

According to the invention, it is preferred that the inflow opening 8b is fluidically connected to the second ventilation channel 20b, which is connected in terms of flow to the environment of the vacuum cleaner 1 by ventilation openings and slots. As a result of this fluidic connection between the outflow opening 8b and the environment of the vacuum cleaner 1, a pressure equalizing air stream can pass into the second chamber 6b through the inflow opening 8b and so a substantial weakening of the negative pressure in the second chamber 6b occurs. The pressure equalizing air stream passes from the environment of the vacuum cleaner into the second chamber 6b through the ventilation channel 20b of the second chamber 6b. The pressure equalizing air stream ensures in the second chamber 6b that the pressure shock element 11b moves down and as a result causes the filter 7b to be dedusted. As a result of the downward movement of the pressure shock element 11b, substantial mechanical shaking of the filter element 7b can occur, wherein an intensity of the shock is set such that any solidified filter cake 24 can be detached from the filter element 7b. Furthermore, it is also possible for loose dust located in the filter element 7b to be shaken off by the mechanical shaking. As illustrated in FIGS. 5 and 8, the detached filter cake 24 drops into the dust collecting tank 5 so that it can be disposed of later together with the rest of the sucked-in dust. It is apparent from FIGS. 4 and 5 that, during the dedusting of the filter element 7b in the second chamber 6b of the vacuum cleaner 1, the air stream 4b is blocked, while the air stream 4a can continue to flow through the first chamber 6a of the vacuum cleaner 1.

Provision can also be made according to the invention for the transmission of the pulse of the pressure equalizing air stream between the pressure shock element 11b and the filter element 7b to take place in a contactless manner. In this case, the pressure shock element 11b and the filter element 7b are designed such that the abrupt compression of the air in the front region of the second chamber 6b is enough to bring about sufficiently great mechanical shaking of the filter element 7b. The exploitation of a pulse of a pressure equalizing air shock for providing efficient filter dedusting with simultaneously continuing suction operation of a vacuum cleaner can preferably also be referred to as backflushing or a backflushing process according to the invention.

At the same time, as a result of the downward movement of the pressure shock element 11b, the turbine opening 9b of the second chamber 6b is closed, such that there is no longer a fluidic flow connection between the second chamber 6b and the turbine 3 of the vacuum cleaner 1. According to the invention, this preferably means that the pressure shock element 11b closes the right-hand flow path, i.e. the path of the second main air stream 4b, which flows from the second chamber 6b through the turbine opening 9b and the flow channel portion 21b in the direction of the turbine 3 of the vacuum cleaner 1. As a result of the flow path through the right-hand chamber 6b being blocked, a negative pressure is prevented from building up or being maintained in the second chamber 6b of the vacuum cleaner 1 and the filter dedusting of the second filter element 7b is promoted.

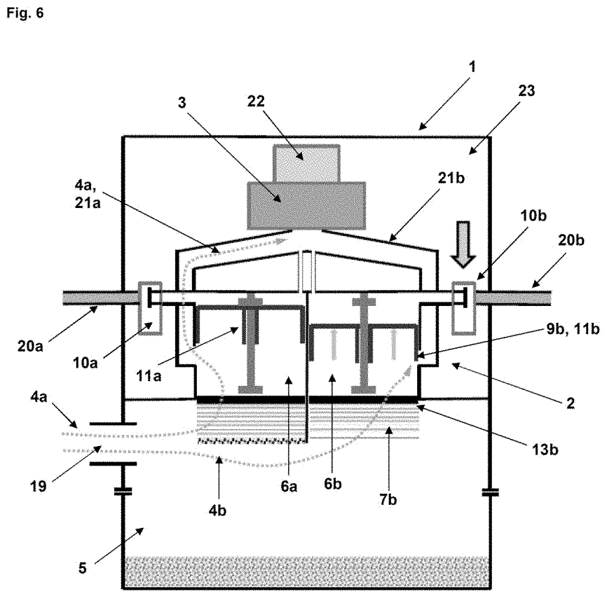

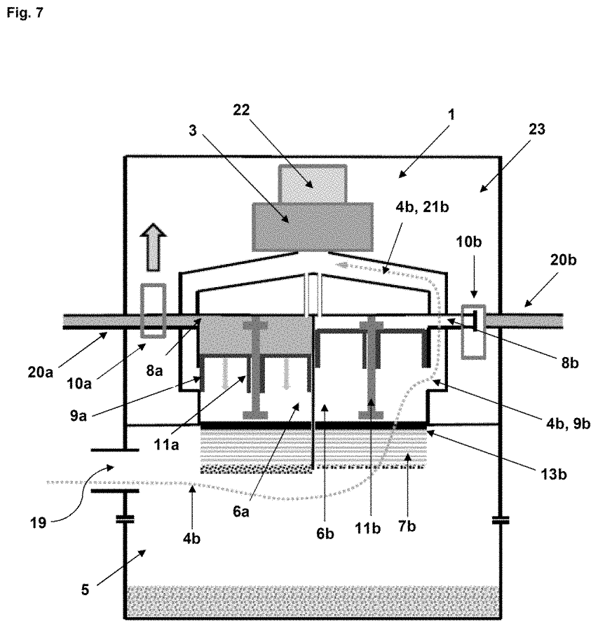

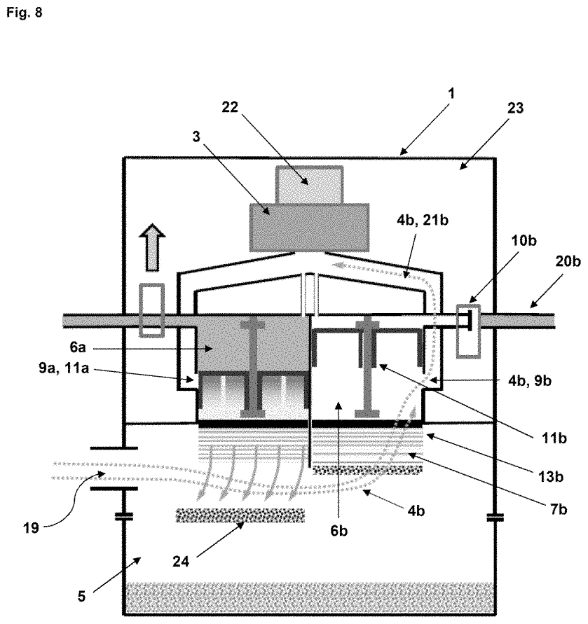

FIG. 6 shows a schematic illustration of the vacuum cleaner 1 at the end of the dedusting process of the second chamber 6b. The end of the dedusting process is started by re-actuation of the valve 10b, wherein the ventilation channel 20b or the inflow opening 8b of the second chamber 6b is closed by the actuation of the valve 10b. The closing of the ventilation valve 10b is indicated in FIG. 6 by the outlined downwardly directed arrow above the valve 10b. As a result of the second ventilation channel 20a being closed, there is no longer a fluidic connection between the second chamber 6b and the environment of the vacuum cleaner 1. The pressure shock element 11b moves back up such that the turbine opening 9b of the second chamber 6b is opened up and a negative pressure can build up in the second chamber 6b again. The movement of the pressure shock element 11b in the “upward” spatial direction is indicated by the two dark arrows which are depicted beneath the pressure shock element 11b. As a result of the turbine opening 9b of the second chamber 6b being opened up, a negative pressure can build up in the second chamber 6b again, as is necessary for carrying out suction operation. In particular, a suction air stream 4b again flows from the dust collecting tank 5 into the second chamber 6b and through the turbine opening 9b onward to the turbine 3. FIGS. 7 to 9 show a filter dedusting process of the first chamber 6a of the filter device 2. In this case, the contents of FIGS. 4 and 7, 5 and 8 and 6 and 9 correspond in each case, wherein the reference signs “b” in the description should be replaced by an “a”. Therefore, a detailed explanation of FIGS. 7 to 9 will not be given. It is apparent from FIGS. 7 and 8 that, during the dedusting of the filter element 7a in the first chamber 6a of the vacuum cleaner 1, the air stream 4a is blocked, while the air stream 4b can continue to flow through the second chamber 6a of the vacuum cleaner 1. The opening of the ventilation valve 10a is symbolized in FIG. 7 by the outlined upward arrow above the valve 10a. In FIG. 8, this arrow means the ventilation valve 10a is open. The dark arrows beneath the pressure shock element 11a, which point downward in FIGS. 7 and 8, symbolize the vertical downward movement of the pressure shock element 11a as a result of the atmospheric pressure penetrating into the first chamber 6a. The dedusting of the filter element 7a that is carried out thereby ensures that the filter cake 24 detaches from the filter element 7a and drops into the collecting tank 5. The suction operation of the vacuum cleaner 1 is continued substantially without an interruption through the second chamber 6b.

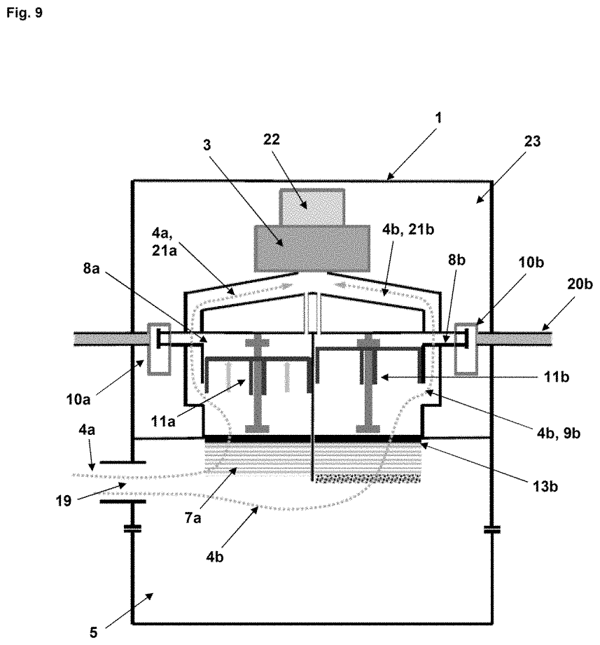

In FIG. 9, the two ventilation valves 10a, 10b are closed. In the first chamber 6a that has just been dedusted, negative pressure builds up again and the pressure shock element 11a moves in an upward spatial direction into the parked position. The two turbine openings 9a, 9b are now open again and the main air streams 4a, 4b can flow through the respective chambers 6a, 6b of the vacuum cleaner 1. Therefore, both flow paths in the vacuum cleaner 1, and the flow channel portions 21a, 21b are open, while the inflow openings 8a, 8b and the ventilation channels 20a, 20b are closed.

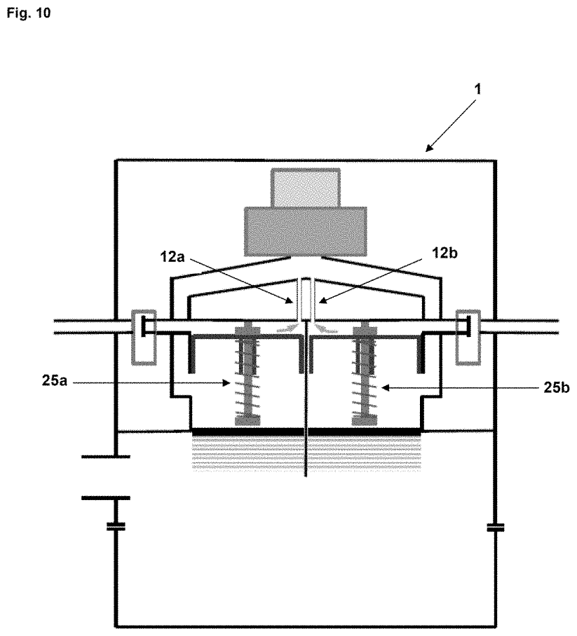

FIG. 10 shows the restoration of the pressure shock elements 11a, 11b following completion of the dedusting of the filter elements 7a, 7b. The restoration of the pressure shock elements 11a, 11b can be implemented technically in particular in two ways. According to a first alternative, what are known as bypass channels 12a, 12b can be provided between the chambers 6a, 6b and the turbine 3, or the turbine inlet, a particularly large negative pressure prevailing in said bypass channels 12a, 12b on account of their design and their vicinity to the turbine 3. This large negative pressure in the bypass channels 12a, 12b of the chambers 6a, 6b can advantageously be used in order to cause the pressure shock elements 11a, 11b to move vertically upward. In other words, the pressure shock elements 11a, 11b can be sucked upward by the large negative pressure prevailing in the bypass channels 12a, 12b, such that they return to the parked position, in which the suction operation through the respective chamber 6a, 6b can be carried out. In addition or alternatively to the bypass channels 12a, 12b, springs 25a, 25b can be provided in the vacuum cleaner 1. These springs 25a, 25b can be for example compression springs which are compressed by the downward movement of the pressure shock elements 11a, 11b. After the end of the dedusting of the filter elements 7a, 7b, the pressure shock elements 11a, 11b can be restored into the parked position with the aid of the spring force stored in the springs 25a, 25b. Therefore, according to the invention, it is preferred that bypass channels 12a, 12b and/or springs 25a, 25b are provided in the chambers 6a, 6b of the vacuum cleaner 1, said bypass channels 12a, 12b and/or springs 25a, 25b being designed to bring about and/or support restoration of the pressure shock elements 11a, 11b.

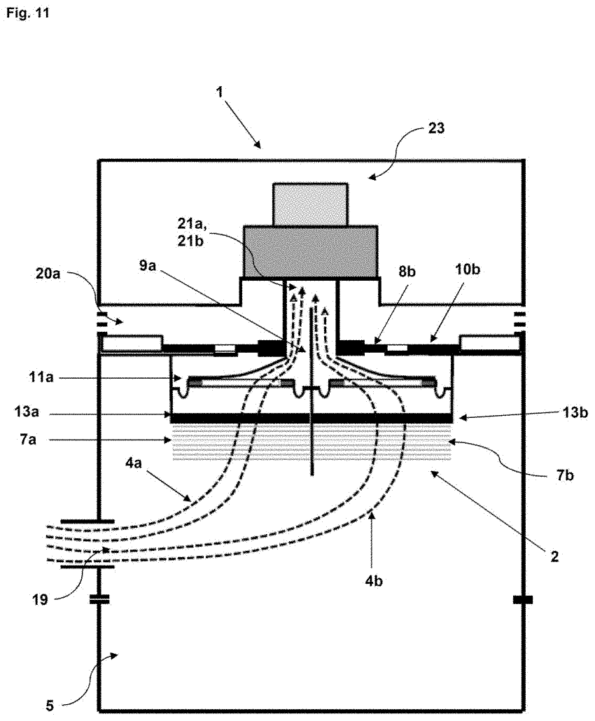

FIG. 11 shows a schematic side view of a vacuum cleaner 1 having a preferred embodiment of the filter device 2 in a horizontal arrangement. What is illustrated is a vacuum cleaner 1 having a vacuum cleaner head 23 in an upper region and a dust collecting tank 5 in a lower region of the vacuum cleaner 1. The turbine 3 and the motor 22 are provided in the vacuum cleaner head 23. The dust collecting tank 5 has a suction hose inlet 19 for connecting a suction hose. Provided in the dust collecting tank 5 are two chambers 6a, 6b, which, in the configuration of the vacuum cleaner 1 illustrated in FIG. 11, are flowed through by air streams 4a, 4b that flow from bottom to top, while the direction of flow in the vacuum cleaner 1 in FIG. 1 (vertical arrangement of the chambers 6a, 6b) is in a lateral direction from right to left or from left to right.

On flowing through the chambers 6a, 6b, the air streams 4a, 4b first of all pass through the filter elements 7a, 7b before they pass through the inlet openings 13a, 13b into the front part of the chambers 6a, 6b. From there, the air streams 4a, 4b continue on their way through the turbine openings 9a, 9b until they pass into the flow channel portions 21a, 21b upstream of the turbine 3. In the process, the turbine openings 9a, 9b are opened up by the pressure shock elements 11a, 11b in the case of suction operation and are closed in the case of dedusting.

The inflow openings 8a, 8b of the chambers 6a, 6b are fluidically connected to ventilation channels 20a, 20b, which are in a flow connection with the environment of the vacuum cleaner 1 (see also FIG. 1). In this way, pressure equalizing streams can pass into the chambers 6a, 6b through the inflow openings 8a, 8b. These pressure equalizing streams weaken the negative pressure in the chamber to be dedusted and the pressure shock elements 11a, 11b are made to move down within the respective chambers 6a, 6b. In the process, the pressure shock elements 11a, 11b generate dedusting pulses in the direction of the filter elements 7a, 7b. The pulses of the pressure equalizing streams can preferably be transmitted to the filter elements 71, 7b by contact or contactlessly, with the result that the filter elements 7a, 7b are mechanically shaken. This in turn results in effective dedusting of the filter elements 7a, 7b.

Tests have shown that especially a horizontal arrangement of the filter device 2 can result in a particularly compact vacuum cleaner 1, in which the filter device 2 takes up only a little installation space.

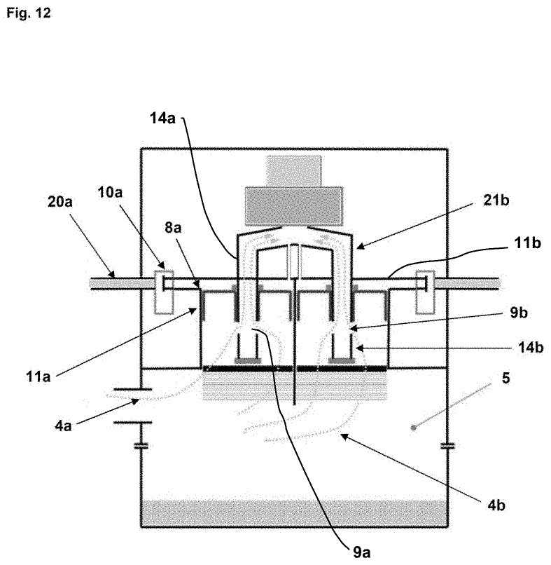

In the exemplary embodiment of the invention illustrated in FIG. 12, the two chambers 6a, 6b of the filter device 2 are participating in the suction operation of the vacuum cleaner 1. The ventilation valves 10a, 10b are closed, as are the inflow openings 8a, 8b of the two chambers 6a, 6b. The pressure shock elements 11a, 11b are in their parked position in the upper region of the chambers 6a, 6b. As a result, the turbine openings 9a, 9b are free and the suction streams 4a, 4b can be sucked in through the turbine openings 9a, 9b in the direction of the turbine 3. In the exemplary embodiment of the invention illustrated in FIG. 12, the turbine openings 9a, 9b are arranged in the axial guides 14a, 14b. The turbine openings 9a, 9b can be formed in particular by opening slots in the axial guides 14a, 14b, wherein the axial guides 14a, 14b can be formed in particular by tubes or can comprise tubes. The flow channel portions 21a, 21b can be located in particular in the axial guides 14a, 14b in this configuration of the invention.

### LIST OF REFERENCE SIGNS

1 Vacuum cleaner
2 Filter device
3 Turbine device
4 Main air stream, 4a: first main air stream, 4b: second main air stream
5 Collecting tank
6 Chamber, 6a: first chamber, 6b: second chamber
7 Filter element, 7a: first filter element, 7b: second filter element
8 Inflow opening, 8a: first inflow opening, 8b: second inflow opening
9 Turbine opening, 9a: first turbine opening, 9b: second turbine opening
10 Valve, 10a: first valve, 10b: second valve
11 Pressure shock element, 11a: first pressure shock element, 11b: second pressure shock element
12 Bypass channels, 12a: bypass channel in the first chamber, 12b: bypass channel in the second chamber
13 Inlet opening, 13a: first inlet opening, 13b: second inlet opening
14 Axial guide, 14a: first axial guide, 14b: second axial guide
19 Suction hose inlet
20 Ventilation channel
21 Flow channel portion
22 Motor
23 Vacuum cleaner head
24 Filter cake
25a and 25b Springs

1-15. (canceled)

16. A filter device for a vacuum cleaner having a turbine device and a motor for generating a first main air stream or a second main air stream through a collecting tank of the vacuum cleaner, the filter device comprising:
a first chamber and a second chamber, each having a filter element and an inflow opening, a valve being designed to open or to close the inflow opening, wherein a negative pressure prevails in the respective first or second chamber when the inflow opening is closed and wherein atmospheric pressure prevails in the respective first or second chamber when the inflow opening is open, the first and second chambers also each including a pressure shock element, the pressure shock elements have a parked position and a dedusting position, a switchover between the parked position and the dedusting position takes place by letting in the atmospheric pressure by actuating the valve, the pressure shock elements being designed to apply a pulse to the respective filter element when the dedusting position is taken up so that the filter element is dedusted.

17. The filter device as recited in claim 16 further comprising turbine openings designed to allow a flow connection between the chambers and the turbine device.

18. The filter device as recited in claim 16 wherein the first and second chambers have inlet openings and wherein the filter elements are designed to close the inlet openings such that dust particles are filtered out of the first and second main air streams.

19. The filter device as recited in claim 16 further comprising axial guides for guiding the pressure shock elements.

20. The filter device as recited in claim 17 wherein the turbine openings are present in side walls of the chambers or in axial guides for guiding the pressure shock elements.

21. The filter device as recited in claim 16 further comprising ventilation channels to connect the chambers to an environment of the vacuum cleaner.

22. The filter device as recited in claim 16 wherein the first and second chambers are arranged alongside one another in the vacuum cleaner.

23. The filter device as recited in claim 16 wherein the first and second main air streams flow into the first and second chambers from the side and are subsequently deflected into a vertical flow.

24. The filter device as recited in claim 16 wherein the first and second main air streams flow into the first and second chambers from below and form a vertical flow.

25. The filter device as recited in claim 16 wherein the first and second chambers have bypass channels or springs designed to support restoration of the pressure shock elements.

26. A method for dedusting a filter device in a vacuum cleaner, the method comprising the following steps:
a) providing the filter device as recited in claim 16;
b) operating the vacuum cleaner, wherein, during operation of the vacuum cleaner, a negative pressure prevails in a collecting tank of the vacuum cleaner and in at least the first chamber or in the second chamber;
c) generating atmospheric pressure in one of the first and second chambers by actuating a valve, wherein, as a result of the valve being actuated, an inflow opening of the respective first or second chamber is opened and a pressure shock element within the respective first or second chamber is made to change position from a parked position into a dedusting position; and
d) dedusting the filter element by the change in position of the pressure shock element.

27. The method as recited in claim 26 wherein when the vacuum cleaner is in operation, a first main air stream or second main air stream is generated, the first or second main air stream forming between a suction hose inlet and the turbine device.

28. The method as recited in claim 26 wherein, when one of the valves is opened, a pressure equalizing stream passes into the first chamber or into the second chamber.

29. The method as recited in claim 26 wherein the filter element of one of the first and second chambers is dedusted upon continued suction operation through the other of the first and second chambers.

30. The method as recited in claim 26 wherein turbine openings designed to allow a flow connection between the chambers and the turbine device are closed by the change in position of the pressure shock element.
